(19) United States
(12) Patent Application Publication
(10) Pub. No.: US 2014/0074731 A1
(43) Pub. Date: Mar. 13, 2014

(54) SYSTEM AND METHOD FOR AUTOMATED DATA DISCREPANCY ANALYSIS

(71) Applicants: Nathan Lande, Arlington, VA (US); Franklin Carroll, Catonsville, MD (US); Yong Chen, Potomac, MD (US); Benjamin Hoffman, Washington, DC (US); Eric Rosenblatt, Derwood, MD (US)

(72) Inventors: Nathan Lande, Arlington, VA (US); Franklin Carroll, Catonsville, MD (US); Yong Chen, Potomac, MD (US); Benjamin Hoffman, Washington, DC (US); Eric Rosenblatt, Derwood, MD (US)

(73) Assignee: Fannie Mae, Washington, DC (US)

(21) Appl. No.: 13/614,661

(22) Filed: Sep. 13, 2012

(51) Int. Cl. G06Q 99/00

(52) U.S. Cl. 705/306

(57) ABSTRACT

A method for automatic detection of inconsistencies in an appraisal by extracting data from the appraisal to create component data arranged into a predetermined set of categories and selecting a control identifier to trigger a generation of comparison data. Further, through a comparison between the comparison data and the component data, inconsistencies within the appraisal are identified.

### BACKGROUND OF THE INVENTION

1. Field of the Invention

This application relates generally to a data discrepancy application, more particularly to a data discrepancy application for automatically detecting inconsistencies in an appraisal using the appraisal data to generate specific and statistical comparisons, and still more particularly to incorporating multiple appraiser histories and statistical variation models to provide reviewers with the ability to identify inconsistencies and outliers that may indicate artificial property valuations.

2. Description of the Related Art

Typically, three recent sales (comparable properties) that are geographically relevant to a subject property are used to calculate the subject property's appraised value. When using comparable properties, appraisers must describe each comparable property's characteristics. This requires the appraisers to complete relative data entry fields for each comparable property on the appraisal.

Further, appraisers usually appraise properties in the same geographic area. Therefore, any given appraiser is very likely to reference the same comparable property multiple times on multiple appraisals. Consequently, it is highly possible that an appraiser may incorrectly enter a comparable property's characteristics. In addition, it is also possible that an appraiser may take liberties in describing comparable properties, such that the appraised value of a subject may be artificially inflated or devalued.

### SUMMARY OF THE INVENTION

The present invention relates to a method for automatic detection of inconsistencies in an appraisal by extracting data from the appraisal to create component data arranged into a predetermined set of categories and selecting a control identifier to trigger a generation of comparison data. Further, through a comparison between the comparison data and the component data, inconsistencies within the appraisal are identified.

The described may be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the described are more fully disclosed in the following specification, reference being had to the accompanying drawings, in which:

FIG. 1 is a block diagram illustrating an examples of a system in which a data discrepancy application operates;

FIG. 2 is a flow diagram illustrating an example of an inconsistency evaluation process;

FIG. 3 is a flow diagram illustrating another example of an inconsistency evaluation process;

FIG. 4 is a flow diagram illustrating an example of an appraiser evaluation process;

FIG. 5 is a flow diagram illustrating an example of an appraisal evaluation process;

FIG. 6 is a flow diagram illustrating an example of an external comparison process;

FIG. 7 is a flow diagram illustrating another example of an inconsistency evaluation process; and

FIG. 8 is a flow diagram illustrating another example of an inconsistency evaluation process.

### DETAILED DESCRIPTION OF THE INVENTION

In the following description, for purposes of explanation, numerous details are set forth, such as flowcharts and system configurations, to provide an understanding of one or more embodiments. However, it is and will be apparent to one skilled in the art that these specific details are not required to practice the described invention.

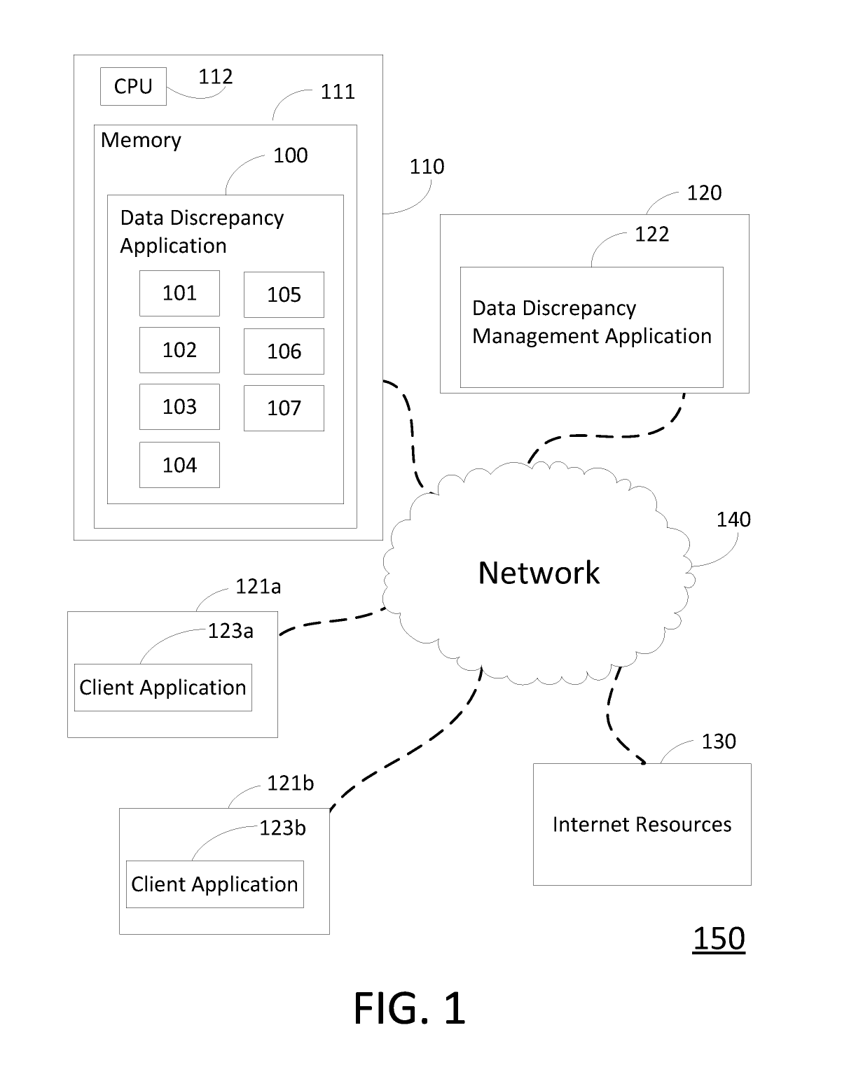

FIG. 1 is a block diagram illustrating an examples of a system in which a data discrepancy application operates. The data discrepancy application is generally a set of instruction configured to automatically detect inconsistencies and data discrepancies, such as statistical outliers indicating user mistake, computer error, misrepresentation, potential fraud, altered property values, and altered property characteristics, in appraisal.

In particular, FIG. 1 illustrates an exemplary system 150 for data discrepancy management. In general, electronic devices 110, 120, and 121 each include applications 122, 123, etc., e.g., as a set of instructions stored in a memory of a device 110, 120, and 121 and executable by a processor of a device 110, 120, and 121. Computing devices, including devices 110, 120, 121, etc. may be any computing device, that may communicate, e.g., via the network 140, with internet resources 130, which may include one or more of a variety of resources, including website databases, file storage databases, media databases, data repositories, and the like that are implemented through hardware, software, or both. That is, although internet resources 130 are shown as a singular block in the figure, but it should be understood that the singular block represents a variety of resources, including financial intuition databases, MLS listings, GIS data, or resources compiled by an information services provider (i.e. tax assessors, other appraising services, and the like). Further, internet resources 130 are typically accessed externally for use by the applications, since the amount of property data is rather voluminous, and since the application is configured to allow access to multiple loan databases and multiple auto resource databases. The application accesses and retrieves the market data from these resources in support of automatically detecting inconsistencies in an appraisal. In addition, in the systems described the application may execute computerized searches for appraisals with high probabilities of misrepresentation. Such that where a search by the application that was initiated by a user is performed on the internet resources 130 for appraisals with outliers.

Further, the exemplary system 150 operates over the network 140, which may be a cellular network; however, it may alternatively or additionally be any conventional networking technology. For instance, network 140 may include the Internet, and in general may be any packet network (e.g., any of a cellular network, global area network, wireless local area networks, wide area networks, local area networks, or combinations thereof, but is not limited thereto). Further, for communication over the network 140, devices 110, 120, 121 may utilize any interface suited for input and output of data including communications that may be visual, auditory, electrical, transitive, etc.

The system 150 includes a device 110; the device 110 in turn includes a data discrepancy application 100 constructed from program code that is stored on a memory 111 and executable by a central processing unit (CPU) 112. The data discrepancy application 100 is generally configured to automatically detect inconsistencies and data discrepancies in an appraisal using an extraction module 101, a compiling module 102, a comparison module 103, a category selection module 104, a subroutine selection module 105, and a user interface module 106, and an application programmable interface module 107. Further, although the data discrepancy application 100 is preferably provided as software (e.g. constructed from program code that is stored on the memory 111 and executable by the CPU 112), the data discrepancy application 100 may alternatively be provided as hardware or firmware, or any combination of software, hardware and/or firmware.

The system 150 further includes a host device 120. The host device 120 in turn includes a host data discrepancy application 122 that, e.g., via a network 140, stores and manages appraisal data for use by client devices 121, which include client applications 123. The host data discrepancy application 122 generally may include any combination of the above modules.

The client device 121, such as a mobile phone, may utilize conventional web browsing or mobile application technology, and may not utilize all of the foregoing modules 101-107. The client application 123 is thus sometimes referred to as a “light” version of the data discrepancy application 100. Thus, in the FIG. 1, the host data discrepancy application 122 that is external to the client device 121, which accesses the functionality of the host data discrepancy application 122. That is, a client device 12, which may be a user device such as laptop computer or a smartphone, may act as terminal where through either web browsing or mobile application technology the data discrepancy application 122 is configured to run in the context of a server or host functionality.

Further, the functionality of the data discrepancy applications 100, 122, 123 may be divided between the devices 110, 120, 121, where modules of the applications may be located separately on the devices and accessed through distributed computing, such that the functionality is provided for, shared, and relied upon by other devices. And, of course, a single computing device (as illustrated by device 110) may be independently configured to include the entire functionality of the data discrepancy application 100. Thus, although one modular breakdown of the data discrepancy application 100 is offered, it should be understood that the same functionality may be provided through any of the above applications using fewer, greater, or differently named modules.

The extraction module 101 includes program code for receiving an appraisal and executing a full extraction of the component data listed on the appraisal. In addition, the data, which comprises the standardized list of descriptors along with a standardized set of rankings that appraisers can choose from when citing a comparable properties and evaluating a subject, is categorized and prepared for the compiling module 102 and the comparison module 103. The extraction module 101 may also use key word and synonym algorithms such that the entire appraisal may be processed.

The compiling module 102 includes program code for analyzing historical data comprising of previously processed appraisals and generating a data set (i.e. comparison information) that is relative to the component data extracted by the extraction module 101. Specifically, the compiling module 102 may parse though previously processed appraisals to identify which appraisals have cited the same comparable properties as the received appraisal and compile the descriptors and rankings from those previously processed appraisals into a comparison information data set.

The comparison module 103 is configured to compare the component data extracted by the extraction module 101 to the comparison information compiled by the compiling module 102 while searching for inconsistencies or contradictions between the data sets. The comparison module 103 may identify inconsistencies or contradictions by direct comparison or through statistical trends across geographic areas, specific categories, appraiser history, and other statistical dimensions. Further, the comparison module 103 may also search for identified contradictions and flag appraisals that possess these contradictions or flag appraisers that consistently contradict themselves or the field.

The category selection module 104 includes program code for designating categories from the set of categories, which may include the property's physical characteristics, such as gross living area, lot size, age, number of bedrooms, and number of bathrooms, as well as location specific effects, time of sale specific effects, and property condition effects (or a proxy thereof). For example, the category selection module 104 may designate at least two categories from the set of categories to generate common transactional parings based on the statistical relationship between the at least two selected categories. Further, the predetermined set of categories may be manipulated or altered by the category selection module 104 for an individual comparable property or subject.

The subroutine selection module 105 includes program code for selection and implementation of the subroutines of the data discrepancy application. In particular, the subroutine selection module 105 includes program code for the below described appraiser evaluator, appraisal evaluator, and external evaluator subroutines.

The user interface module 106 includes program code for generating a user interface for managing the display and receipt of information from a user to provide the described functionality. The user interface permits user management of the data discrepancy application 100. Further, the user interface permits the application 100 to be displayed in a map, menu, icon, tabular, or grid format, with various functional representations according to a module's required functionality. That is, the user interface is configured to provide mapping and analytical tools that implement the data discrepancy application's mapping features to display neighborhoods, counties, census block groups, school districts, and the like (including customizable zones). For example, mapping features include the capability to display the boundaries of a school district with clickable icons indicating the geographic location of comparable properties within the school district. Additionally, a table or grid of data may concurrently be displayable so that the clickable icons within the screen view are also listed on the table in a row and column database format. The grid/table view allows the user to sort the list of promotions based on condition, view, lot size, age, bedrooms, or any other dimensions. Additionally, the rows in the table are connected to full database entries as well as the appropriate computer resources that support said database entries. Combined with the map view, this allows for a convenient and comprehensive interactive analysis of appraisals by the data discrepancy application 100.

The application programmable interface module 107 is configured to communicate directly with other applications, modules, models, devices, and other sources through both physical and virtual interfaces. The application programmable interface module 107 manages the dispatching and receipt of information in relation to the above sources and sources external to the application along with integrating the application 100 with other applications and drivers, as needed per operating system.

Thus, a way of implementing the above applications 122, 123, etc., e.g., is as a set of instructions stored in a memory and executable by a processor to perform a method for automatic detection of inconsistencies in an appraisal. For example, the appraisal and its data may be received by the applications 122, 123, etc., via direct entry of the appraisal data through user interface, as generated by the user interface module 107, or through an electronic processing by the extraction module 101 and application programmable interface module 107. Further, using numerous sources of information (including multiple prior representations by a particular appraiser of a subject or comparable property as provided by internet resources 130 and storage local to the device in which the applications 122, 123, etc., are installed upon), the applications 122, 123, etc., detects inconsistencies and data discrepancies in appraisal data entry, by comparing via the comparison module 103 the appraisal data entry to other appraisal data entries, to public records, to MLS listings, to GIS data, and to other statements about a property by that same appraiser or by others. That is, by comparing descriptions, the data discrepancy application can indicate if any of the descriptors are possibly false or at the very least inconsistent with the additional information.

Thus, the data discrepancy application performs cross checking of digitally collected and generated information while reducing the flexibility of appraisers to mistakenly enter or modify information about subjects and comparable properties in ways that generate or support improper values of subjects. Further, the data discrepancy application allows for computerized searches for pre-loaded appraisals with high probabilities of misrepresentations. Furthermore, the data discrepancy application permits a reviewer to use a graphic user interface that may include tables and mapping features alongside additional information, as described above, to perform the cross checking and other computerized searches.

In one embodiment, the data discrepancy application performs a method for automatic detection of inconsistencies and data discrepancies in an appraisal by extracting, by a computer, data from the appraisal to create component data arranged into a predetermined set of categories, selecting, by a computer, a control identifier to trigger a generation of comparison data, and identifying, by a computer, inconsistencies based on a comparison between the comparison data and the component data. That is, the method monitors and finds a lack of consistency with the descriptions of the comparable properties. It may be the case that the same appraiser does multiple (two, five, or more) appraisals for property or refinancing transactions in the same area, because they possess intimate knowledge of a neighborhood or frequently service a specific region. When producing multiple appraisals for property or refinancing transactions in the same area, appraisers may use the same comparable property or transaction as appraisals require the selection of three comparable properties (when available) to appraise a subject.

The date of comparable properties or transactions does not usually change. Thus, when a sale of a comparable property is listed on the appraisal, the sale date and its characteristics are usually fixed. Further, it should be the case that because comparable transactions are fixed events in history with fixed characteristics, they should be reported with the same characteristics every time these fixed events are reported. Yet, this is not the case, as appraisers may take liberties in describing comparable transactions each time they use or report the comparable transaction or may mistakenly enter the descriptions on the appraisal form. These variations of descriptions, among other discrepancies, are what the method for automatic detection of inconsistencies and data discrepancies seeks and monitors.

For instance, a comparable property is given a first (a high) rating when listed on a first appraisal (Appraisal 1), while that same comparable property was given a different (low) rating when listed on a second appraisal (Appraisal 2). In this case, Appraisal 1 and Appraisal 2 were created by the same appraiser. Further, this rating variation may indicate that either the appraiser, who issued both Appraisal 1 and 2, made a mistake in one of the two listings or that the appraiser intentionally rated the comparable property in a way that justifies the price evaluation of the subject property. In the former case, this mistake must be corrected so the subject may be evaluated correctly. In the latter case, the appraiser is fraudulently manipulating the comparable property's characteristics to justify a property evaluation (i.e. inflating or devaluing prices for different subjects). Fraud and misrepresentation clearly need to be addressed to protect the public and identified so that the subject may be evaluated correctly. Thus, the method for automatic detection of inconsistencies and data discrepancies (i.e. the data discrepancy application) extracts data from both Appraisal 1 and Appraisal 2 to create component data arranged by categories, such as condition rating, and identifies the rating inconsistency between Appraisal 1 and 2 based on a comparison of the extracted data.

Further, for instance, the method for automatic detection of inconsistencies and data discrepancies may extract data from only a single appraisal (e.g. only Appraisal 2) to specifically compare the condition rating (a low rating) of the comparable property with the age (in this case new construction) of that comparable property. That is, the data discrepancy application checks whether the condition rating of the comparable property is correctly relative to the age of that comparable property. In particular, because the comparable property was new construction on the date of the transaction, the condition rating must necessarily be high. Yet, as indicated above, the condition rating was low, which is generally given to damaged or older properties. Furthermore, for instance, the data discrepancy application may extract data from a third appraisal (Appraisal 3), which was produced by an appraiser other than appraiser who produced Appraisal 1 and 2, to analyze whether the rating for the comparable property in Appraisal 2 was given the same rating as was given to that comparable property in Appraisal 3. Thus, the data discrepancy application identifies these variations (between Appraisals and between expected and actual ratings) as inconsistencies. More plainly, the application has at least three comparison subroutines for inconsistency evaluation.

One subroutine, which may be referred to as an appraiser evaluator or appraiser identifier subroutine, looks for an appraiser being consistent with themselves every time they cite a comparable property. In operation, the application would receive an appraiser evaluation request and then subsequently identify the appraiser listed on an appraisal. Alternatively, the application may retrieve the identity of an appraiser by registration number or similar means. Once the appraiser is identified, the transactional history of that appraiser is generated or retrieved. The appraiser transactional history report would contain, for example, property repetition statistics, which may include the number of times a comparable property has been listed by the identified appraiser. Further, the appraiser transactional history report may show statistical tendencies of the identified appraiser, which may include specific description trends. With the appraiser transactional history generated, the application may perform a comparison along the predetermined set of categories between the appraiser transactional historical data and the extracted component data.

For example, the appraiser evaluation subroutine would compare X to Yᵢ₋₁ where ‘X’ is the specific component data in a designated category for one of the three comparable properties or subject extracted from the appraisal being evaluated, ‘Y’ is the appraiser specific transactional historical data in the designated category for the one of the three comparable properties or subject, and T is each instance that the one of the three comparable properties or subject is cited. That is, if an appraiser has cited a specific comparable property 50 times other than the instance being evaluated then ‘i’=50. Further, if the designated category is home condition, then the appraiser may assign a “1”-“5” rating, where “1” is the highest rating that designates a brand new property, “2” is the next highest rating that designates a nearly new and undamaged property, “3” is a neutral rating, “4” is the second lowest rating that designates a property in poor condition, and “5” is the lowest rating that designates a damaged or unfit property.

Further, Table 1: Sample Appraiser Evaluation With Consistency shows that the condition category for a comparable property listed on the appraisal (Appraisal X) being evaluated that was produced by the identified appraiser is consistent with the appraiser's historical transactional data regarding the condition of that comparable property.

TABLE 1
Sample Appraiser Evaluation With Consistency

| X | Y₀ | Y₁ | Y₂ | Y₃ | Y₄ | Y₅ | Y₆ | Y₇ | . . . | Y₄₈ | Y₄₉ |
|---|---|---|---|---|---|---|---|---|---|---|---|
| 2 | 2 | 2 | 2 | 2 | 2 | 2 | 2 | 2 | . . . | 2 | 2 |

Furthermore, Table 2: Sample Appraiser Evaluation With An Indentified Inconsistency shows that the condition category for a comparable property listed on Appraisal X is inconsistent with the appraiser's historical transactional data regarding the condition of that comparable property. Thus, the application flags Appraisal X for further evaluation. It should be noted that the situation in Table 2 may indicate a mistake by the appraiser.

TABLE 2
Sample Appraiser Evaluation With An Identified Inconsistency

| X | Y₀ | Y₁ | Y₂ | Y₃ | Y₄ | Y₅ | Y₆ | Y₇ | . . . | Y₄₈ | Y₄₉ |
|---|---|---|---|---|---|---|---|---|---|---|---|
| 1 | 2 | 2 | 2 | 2 | 2 | 2 | 2 | 2 | . . . | 2 | 2 |

Table 3: Sample Appraiser Evaluation With Multiple Inconsistencies shows the situation where not only is the condition category for a comparable property listed on Appraisal X inconsistent with the appraiser's historical transactional data, but it also shows that the appraiser's historical transactional data is generally inconsistent. Thus, the application flags Appraisal X and the appraiser for further evaluation. It should be noted that the situation in Table 3 may indicate the potential for fraud and misrepresentation by the appraiser.

TABLE 3
Sample Appraiser Evaluation With Multiple Inconsistencies

| X | Y₀ | Y₁ | Y₂ | Y₃ | Y₄ | Y₅ | Y₆ | Y₇ | . . . | Y₄₈ | Y₄₉ |
|---|---|---|---|---|---|---|---|---|---|---|---|
| 2 | 1 | 3 | 3 | 2 | 2 | 2 | 1 | 2 | . . . | 3 | 1 |

Another subroutine, which may be referred to as an appraisal evaluator or appraisal identifier subroutine, looks for an appraisal to be consistent within itself. In operation, the application would receive an appraisal evaluation request and then subsequently analyze the subject and comparable characteristics for consistent descriptor parings. Once the appraisal is identified, the common transactional parings are generated or retrieved. Specifically, the application may designate at least two categories from the predetermined set of categories to generate common transactional parings based on the statistical relationship between the at least two categories.

For example, contradictions within a single appraisal can be readily identified by checking for descriptors pairings that are common. For instance, a new property should always receive a condition rating of “1,” and nearly new properties and renovated property should receive a condition rating of “2.” This is because when comparing a comparable property's condition to its age, a new house should be in good condition and, similarly, a house that is not new but is renovated should also be in good condition. Thus, when a comparable property is over an age that would no longer warrant a “new” designation and an appraiser rates that property as a “1,” then the data discrepancy application would flag this uncommon paring as an inconsistency. Further, another common paring would be a location designation of “beach front” and a view descriptor of “view of the water.” Yet, an appraiser might describe a property as having a “view of the water” while GPS and GIS tools indicate there is no body of water in the vicinity of the home.

Another subroutine, which may be referred to as an external evaluator or external comparison subroutine, looks for an appraiser's descriptor to be consistent with other appraiser descriptors across multiple comparable property citation. In operation, the application would receive an external evaluation request and then subsequently identify the appraiser listed on an appraisal. Alternatively, the application may retrieve the identity of an appraiser by registration number or similar means. Once the appraiser and the comparable property are identified, the transactional citation history relative to that comparable property is generated or retrieved with exclusions applied to comparable cites related to the original appraiser. The transactional citation history would contain, for example, property description statistics, which may include statistics on which descriptors are used for specific categories. With the transactional citation history generated, the application may perform a comparison along at least one of the predetermined set of categories between the transactional citation history data and the extracted component data.

Accordingly, in any of the above subroutines, the predetermined set of categories for an individual comparable property or subject may include the property's physical characteristics, such as gross living area, lot size, age, number of bedrooms, and number of bathrooms, as well as location specific effects, time of sale specific effects, and property condition effects (or a proxy thereof). These are merely examples of what the predetermined set of categories could include, and an ordinarily skilled artisan would readily recognize that various different categories may be used in conjunction with the present data discrepancy application despite those categories not being named herein.

According to one aspect, the data discrepancy application includes program code stored on a non-transitory computer readable medium executable to perform operations for automatic detection of inconsistencies in an appraisal including extracting, by a computer, data from the appraisal to create component data arranged into a predetermined set of categories, selecting, by a computer, a control identifier to trigger a generation of comparison data, and identifying, by a computer, inconsistencies based on a comparison between the comparison data and the component data. The evaluation features will now be described in further detail through the below examples.

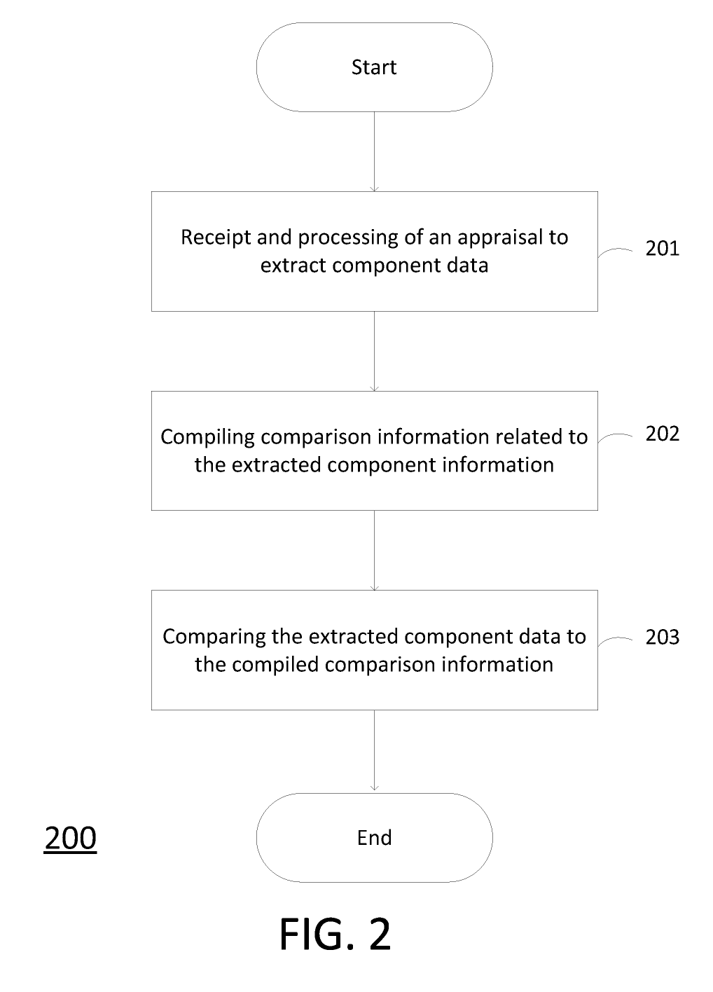

FIG. 2 is a flow diagram illustrating an example of an inconsistency evaluation process. Specifically, FIG. 2 is a flow diagram illustrating an example of an inconsistency evaluation process 200. The inconsistency evaluation process 200 begins by receiving 201 and processing an appraisal.

For instance, computer entered appraisals are sent to financing institutions by the thousands, where on any given week a financing institution may receive 20,000 appraisals. Amongst those appraisals, a single property may be used as a comparable property on the order of 50 times, where one individual appraiser may cite the comparable property 10 times. Therefore, every time a property (whether a subject or a comparable property) is mentioned on an appraisal, that instance is recorded and stored in a database, which is further described below.

The received appraisal is then processed, such that the data listed within the appraisal is extracted and categorized. That is, the appraisal and its data are categorized and prepared for the comparison portion of the process 200. The data comprises a standardized list of descriptors along with a standardized set of rankings that appraisers can choose from when citing a comparable properties and evaluating a subject. For instance, when completing the “view” category for a comparable property, an appraiser must choose the appropriate descriptor. When a comparable property has a mountain view the appropriate descriptor may be “mountains.” When the comparable property has a view of power lines, the appropriate descriptor may be “power lines.” The mountain view is probably not adverse and would likely receive a “1” rating, while the view of the power lines is probably not beneficial and would receive a “3” rating. If a comparable property has a view of both, the comparable property may receive a “2” rating. It is contemplated that standardized lists may grow and change; therefore, processing may also use key word and synonym algorithms such that the entire appraisal may be processed. Thus, regardless of which descriptors and rankings are listed on the appraisal, processing the appraisal is a full extraction of the component data listed on the appraisal.

The process 200 then compiles 202 comparison information related to the extracted component information. Compiling may also be performed simultaneous with receipt 201 and extraction of component data. To compile comparison information, the process analyzes historical data comprising of previously processed appraisals and generates a data set that is relative to the extracted component data. That is, once the comparable properties on an appraisal are identified, the process 200 may parse though previously processed appraisals to identify which appraisals have cited the same comparable properties as the received appraisal. Further, the process 200 compiles the descriptors and rankings from those previously processed appraisals into a comparison information data set.

The process 200 then compares 203 the extracted component data to the compiled comparison information to search for inconsistencies or contradictions between the two. The process 200 may identify inconsistencies or contradictions by direct comparison or through statistical trends. Regarding statistical trends, the process may identify that, in general or for certain geographic areas, specific categories vary more than others. That is, the bedroom number is a precarious category because there is not a standard for defines a bedroom. Thus, it may be the case that an appraiser lists three bedrooms for the first comparable property cite and four bedrooms for the second comparable property cite. Alternatively, it sometimes is the case that when new appraisal categories or descriptors, which are unfamiliar to appraisers, are introduced to the appraisal process, appraiser believe they have more liberties with those new credentials. Thus, the variation likelihood is higher for these new appraisal categories.

Further, the process may also search for identified contradictions and flag appraisals that possess these contradictions or flag appraisers that consistently contradict themselves or the field. For instance, when the process identifies a major error, such as a variation in square footage for a comparable property, the process flags the relative appraiser for immediate review. Thus, the process 200 identifies everything that appraiser has ever appraised and check whether the square footage inconsistency is routine.

By identifying inconsistencies, the process seeks both mistakes in listing and manipulations of characteristic, which both produce improper subject valuations. This is because any deviation in the characteristics of a comparable property directly throws off how comparable properties match the subject and how the comparable properties contribute to subject valuation. In other words, to produce correct subject valuations, appraisers must use the best available comparable properties. To find the best available comparable properties, the appraiser must find the comparable properties with the closest matching characteristics to the subject. Thus, the process is a quality control algorithm that checks whether appraisers are picking and choosing matches and manipulating characteristics to improperly appraise a home. On the other hand, the process may also identify whether a condition is used to repetitively. That is, when an appraiser is devoid of freshness in citing a comparable property, such that their descriptions are banal, the subject valuation may also be inaccurate. Thus, the process 200 is a truth finder, as it receives what appraisers are stating as the truth for a property and identifies whether appraisers are sticking with that truth.

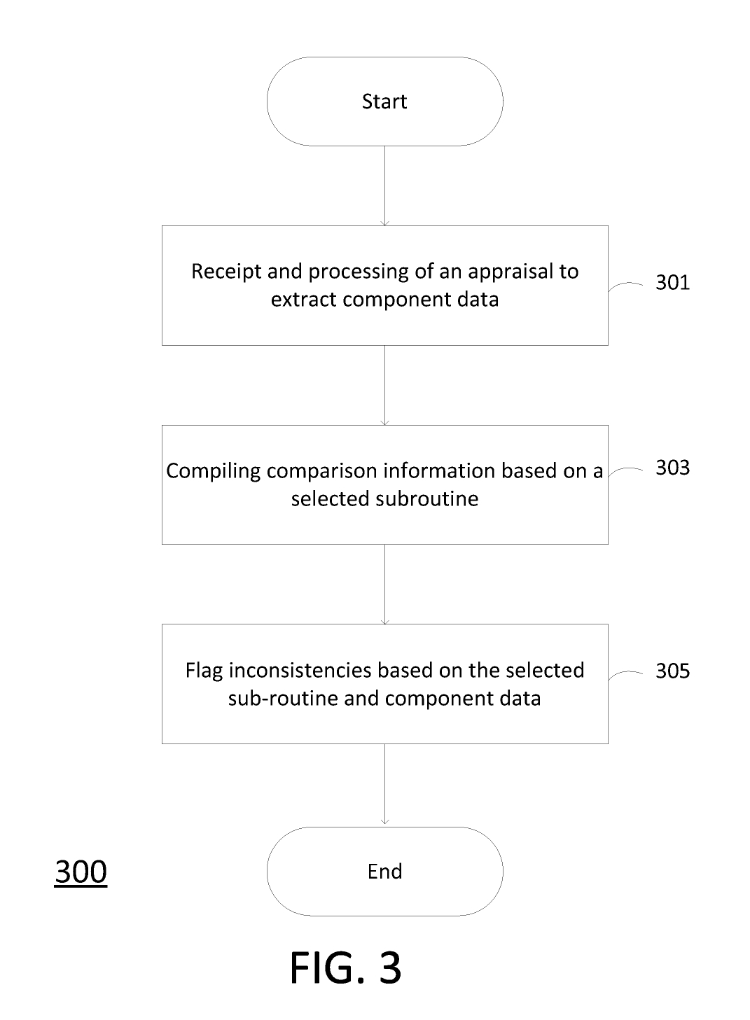

FIG. 3 is a flow diagram illustrating another example of an inconsistency evaluation process. Specifically, FIG. 3 is a flow diagram illustrating an example of the inconsistency evaluation process 300 that describes one possible operation sequence for the data discrepancy applications 100, 121, 123. The inconsistency evaluation process 300 begins by receiving and processing 301 an appraisal, similar to the receiving 201 and processing of an appraisal in process 200 above.

The process 300 then compiles 303 comparison information based on an inconsistency evaluation subroutines. That is, once a subroutine is selected by automatic initiations, default configurations, or user specified selection, the comparison information is specifically compiled for that selected subroutine. When the appraiser evaluation subroutine is selected, the process 300 compiles comparison information based on an identified appraiser and analyzes historical data comprising of previously processed appraisals by the identified appraiser. When the appraisal evaluation subroutine is selected, the process 300 compiles comparison information based on consistent descriptor parings. When the external evaluation subroutine is selected, the process 300 compiles comparison information based on descriptor usage across multiple comparable property citations. Compiling may also be performed simultaneous with receipt 301 and extraction of component data.

The process 300 then compares 305 the extracted component data to the compiled comparison information, which was based on the selected subroutine, to flag inconsistencies or contradictions. The process 300 may identify inconsistencies or contradictions by direct comparison or through statistical trends.

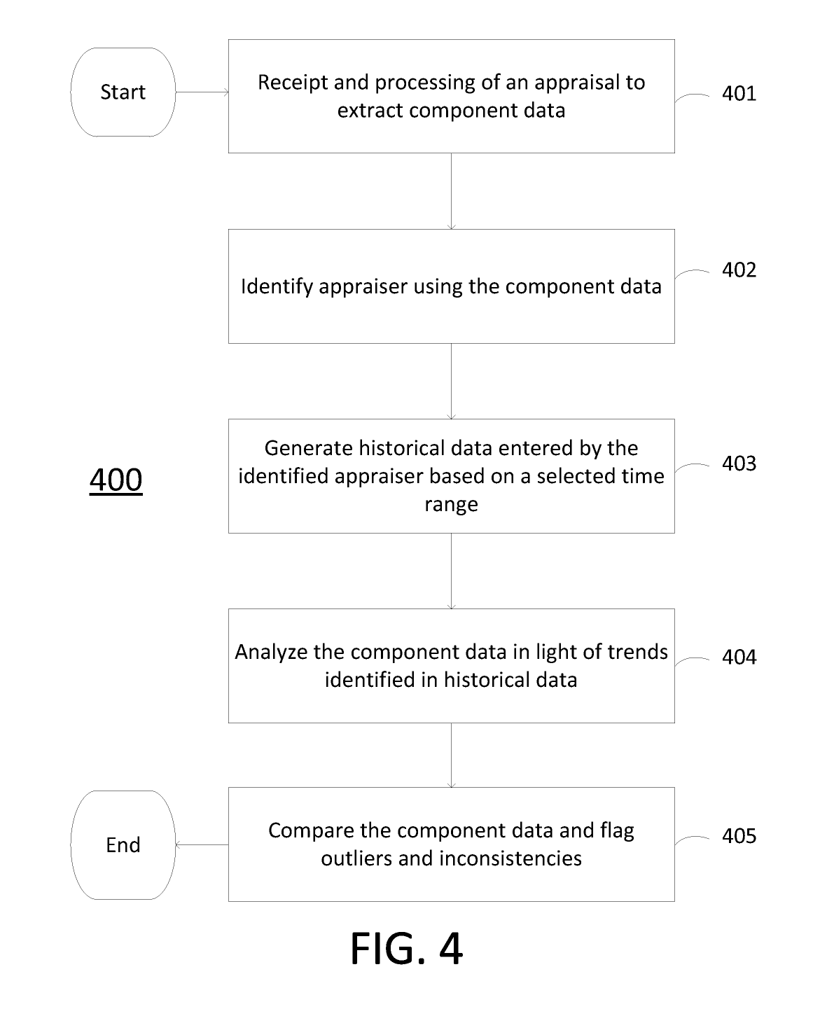

FIG. 4 is a flow diagram illustrating an example of an appraiser evaluation process. Specifically, FIG. 4 is a flow diagram illustrating an example of the appraiser evaluation process 400 that describes one possible operation sequence for the data discrepancy applications 100, 122, 123. The appraiser evaluation process 400 begins by receiving 401 and processing an appraisal, similar to the receiving 201 and processing of an appraisal in process 200 above. Further, the process 400 identifies 402 the appraiser listed in the component data. Alternatively, the process 400 may retrieve the identity of an appraiser by registration number or similar means.

Next the process generates 403 historical data entered by the identified appraiser based on a selected time range. That is, once the appraiser is identified, the transactional history of that appraiser is generated or retrieved based on a selected time range. The time range may vary based on the desired data set. Thus, the process 400 or a user has the option to isolate certain portions of the appraiser transactional history (i.e. vary the range of the appraiser transactional history report). Next, the process analyzes 404 the component data in light of the statistical tendencies found in the appraiser transactional history report and compares 405 the component data and the appraiser transactional history report along the predetermined set of categories, such that inconsistency and outliers may be flagged. For example, the appraiser evaluation process 400 may compare X to Yᵢ₋₁ where ‘X’ is the component data for one of the three comparable properties or subject in a designated category extracted from the appraisal being evaluated, ‘Y’ is the data from the appraiser transactional history report, and ‘i’ is each instance that the one of the three comparable properties or subject are cited in the appraiser transactional history report. Further, the process may employ third party sources to verify the descriptors used in the appraisal component data and the appraiser transactional history report.

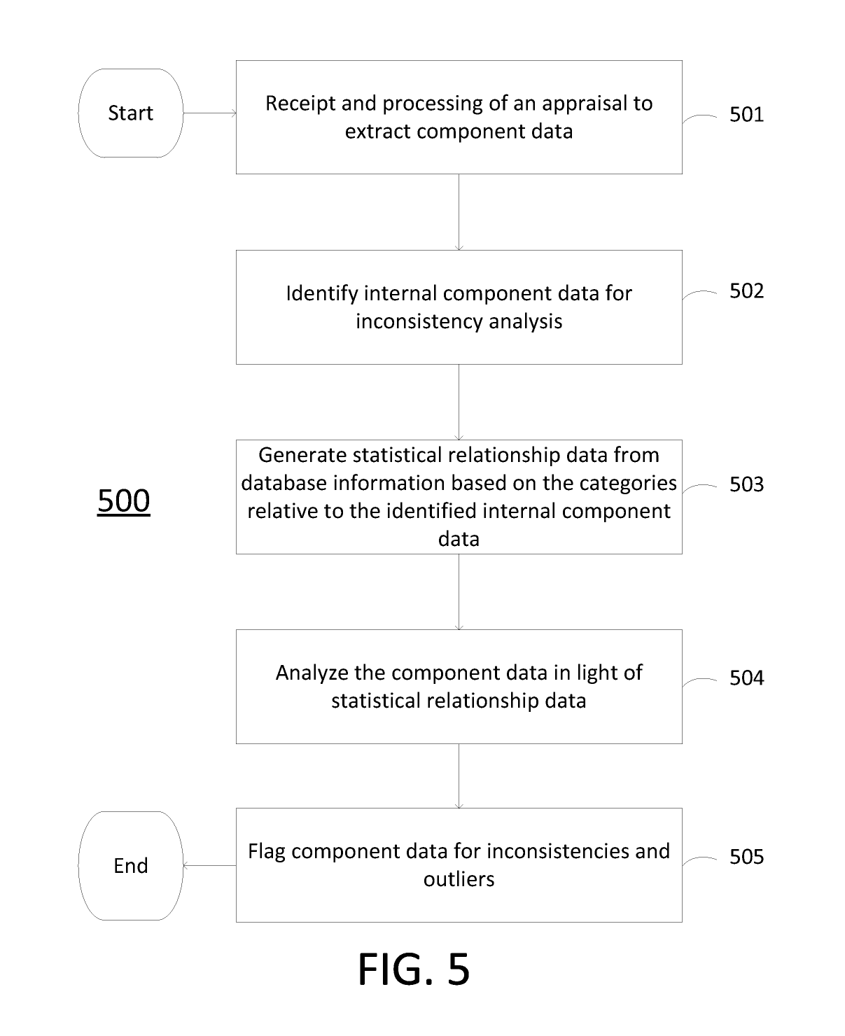

FIG. 5 is a flow diagram illustrating an example of an appraisal evaluation process. Specifically, FIG. 5 is a flow diagram illustrating an example of the appraisal evaluation process 500 that describes one possible operation sequence for the data discrepancy applications 100, 122, 123. The appraisal evaluation process 500 begins by receiving 501 and processing an appraisal, similar to the receiving 201 and processing of an appraisal in process 200 above. Further, the process 500 identifies 502 which internal component data may be subjected to an inconsistency analysis. That is, the process designates at least two categories from the predetermined set of categories to generate common transactional parings based on the statistical relationship between the at least two categories. Once the internal component data and relative categories are identified 502, the process 500 based on the categories relative to the identified internal component data generates 503 statistical relationship data, which identifies consistent descriptor parings and common transactional parings. Next, the process analyzes 504 the component data in light of the statistical relationships found in the statistical relationship data and flags 505 component data inconsistency and outliers.

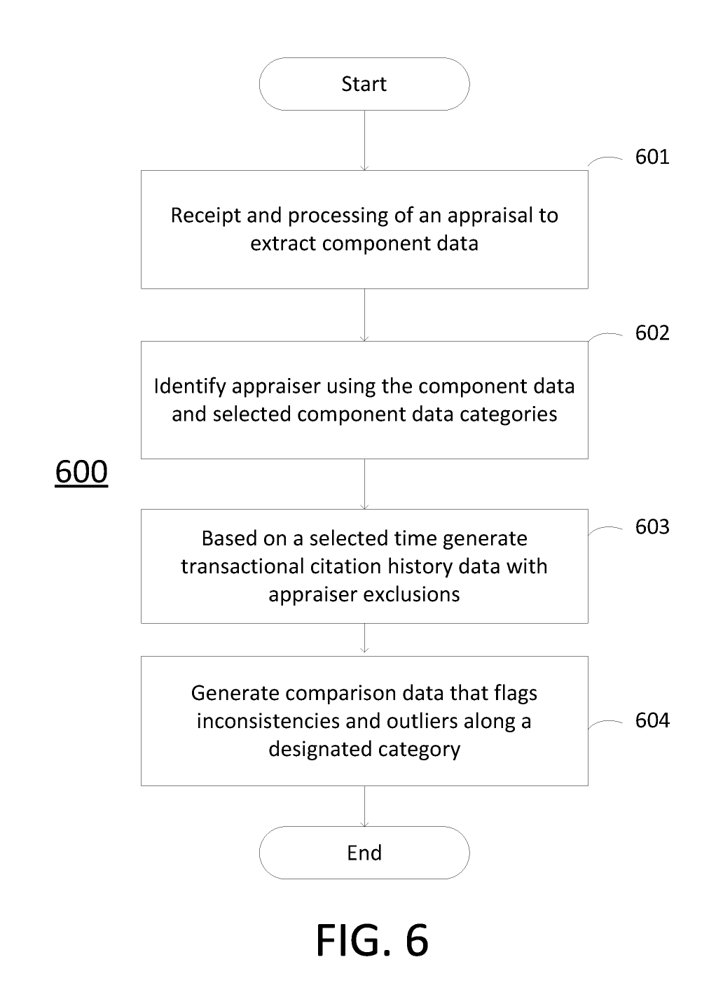

FIG. 6 is a flow diagram illustrating an example of an external comparison process. Specifically, FIG. 6 is a flow diagram illustrating an example of the external comparison process 600 that describes one possible operation sequence for the data discrepancy applications 100, 122, 123. The external comparison process 600 begins by receiving and processing 601 an appraisal, similar to the receiving 201 and processing of an appraisal in process 200 above. Further, the process using the component data identifies 602 the appraiser and designates a comparable property and at least one category from the predetermined set of categories. Alternatively, the process may retrieve the identity of an appraiser by registration number or similar means. Once the appraiser, comparable property, and categories are identified 602, the process based on the comparable property generates 603 a transactional citation history relative to that comparable property with exclusions applied to comparable property citations by the identified appraiser within a selected time range. And like the time range of FIG. 5, the time range may vary based on the desired data set. Thus, the process 600 or a user may isolate certain portions of the transactional citation history if a default setting of ‘all the available data’ is too voluminous. Next, the process 600 generates 604 comparison data that flags contradictions along the selected category based on the transactional citation history.

In the above subroutine examples for the data discrepancy application, the appraiser evaluation and appraisal evaluation subroutines may be considered subroutines that identify for internal inconsistencies. That is, the appraiser evaluation subroutine identifies whether an appraiser is consistent with themselves and the appraisal evaluation subroutine identifies whether an appraisal has internal contradictions. On the other hand, the external comparison subroutine may be considered a subroutine that identify for external inconsistencies, such as whether property citations outside of the appraisal or appraiser are consistent with those inside the appraisal or appraiser.

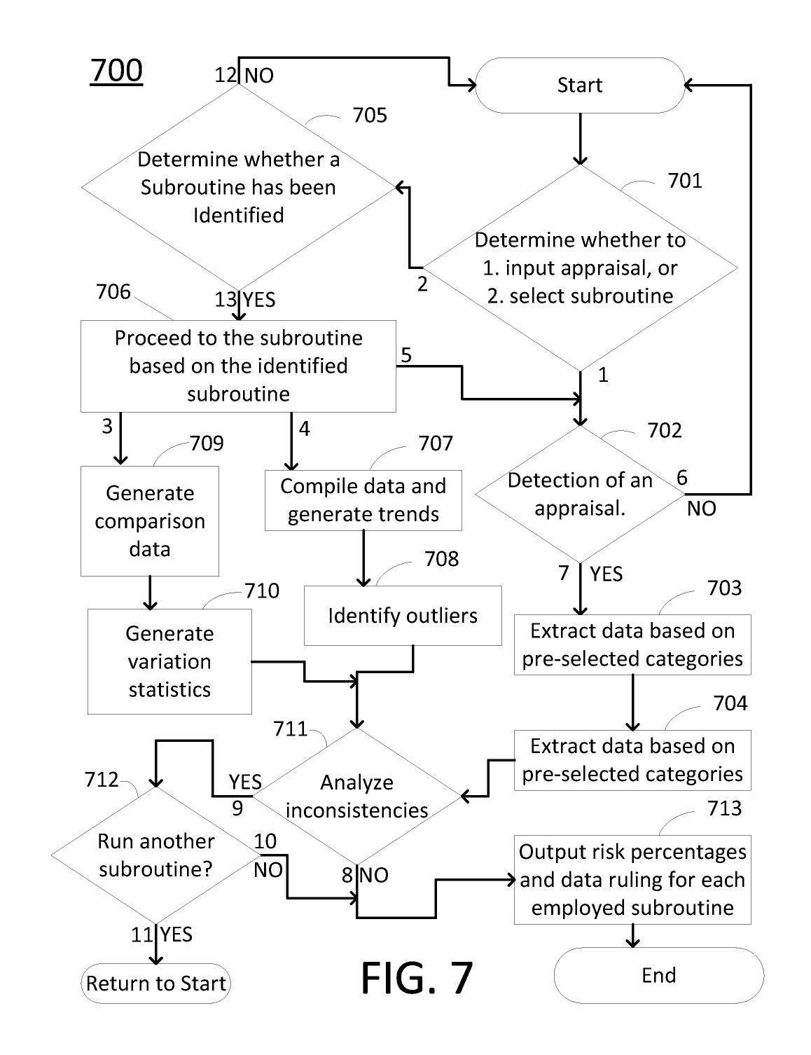

FIG. 7 is a flow diagram illustrating another example of an inconsistency evaluation process 700. Specifically, the inconsistency evaluation process 700 illustrates one possible operation sequence for the data discrepancy applications 100, 122, 123. The inconsistency evaluation process 700 begins with a determination 701 of whether the direct entry of an appraisal or identifying a subroutine is desired. For example, a user can be offered a bypass prompt that permits a choice of (1) directly inputting or submitting an appraisal or (2) selecting a subroutine. When option (1) is chosen, the process then detects 702 whether an appraisal has been inputted. The process may wait for a designated amount of time that may be cut short by receipt of an exit command. If an exit command is received or if the designated amount of time expires then an appraisal may not (6) be input, and the process may return to the start. If an appraisal is submitted or inputted (7), the process proceeds to extract 703 the appraisal data based on preselected categories. The preselected categories may be set by default, where the selected categories are those that are commonly manipulated, or may be manually chosen. After the process extracts the appraisal data, the appraisal data is analyzed 704 based on statistical trends to identify inconsistent parings (which is similar to the appraisal evaluation subroutine described above). Any identified inconsistencies are then analyzed 711 over a set of metrics. If a threshold set of metrics are exceeded (9) by the inconsistencies and data discrepancies, the process checks 712 whether another subroutine should be used to evaluate the appraisal.

If a desired set of information was produced based on the prior phases then the process may forgo running additional subroutines (e.g. a user may chose no (10) when prompted whether another subroutine should be executed) and output 713 a risk percentage and data discrepancy ruling for the appraisal that was inputted during the input appraisal phase 702. Using the risk percentage and data discrepancy ruling the process or a user may make an educated decision as to whether an appraisal or appraiser should be further investigated. After these conclusions are outputted 713 the process ends (END).

If more information is desired, then the process may run (e.g. a user may chose yes (11) when prompted whether another subroutine should be executed) additional subroutines by returning to the start (START) and carrying a new option set. Continuing with the above case, when the process resets and arrives at the appraisal determination 701, the process may automatically choose to (2) select a subroutine and move directly to determining 705 which subroutine is executed next. Note that it is an option to eliminate any subroutine that has already been executed by the process from the set of options from which the process may execute as the metrics for that subroutine were most likely already exceeded 711 and do not need to be compiled again. In this case, the process may either perform an external evaluation subroutine (3) or appraiser evaluation subroutine (4), as the process is building further metrics on top of the previously run appraisal subroutine. Both the external evaluation subroutine (3) and the appraiser evaluation subroutine (4) and their subsequent paths are similar to that of the external evaluation subroutine and appraiser evaluation subroutine, respectively described above.

Thus, FIG. 7 illustrates an example of the inconsistency evaluation process 700 that implements all of the above subroutines into one operation sequence for the data discrepancy applications 100, 122, 123, such that the inconsistency evaluation process 700 is a comprehensive data discrepancy identification mechanism that uses an aggregate score to produce a risk ruling.

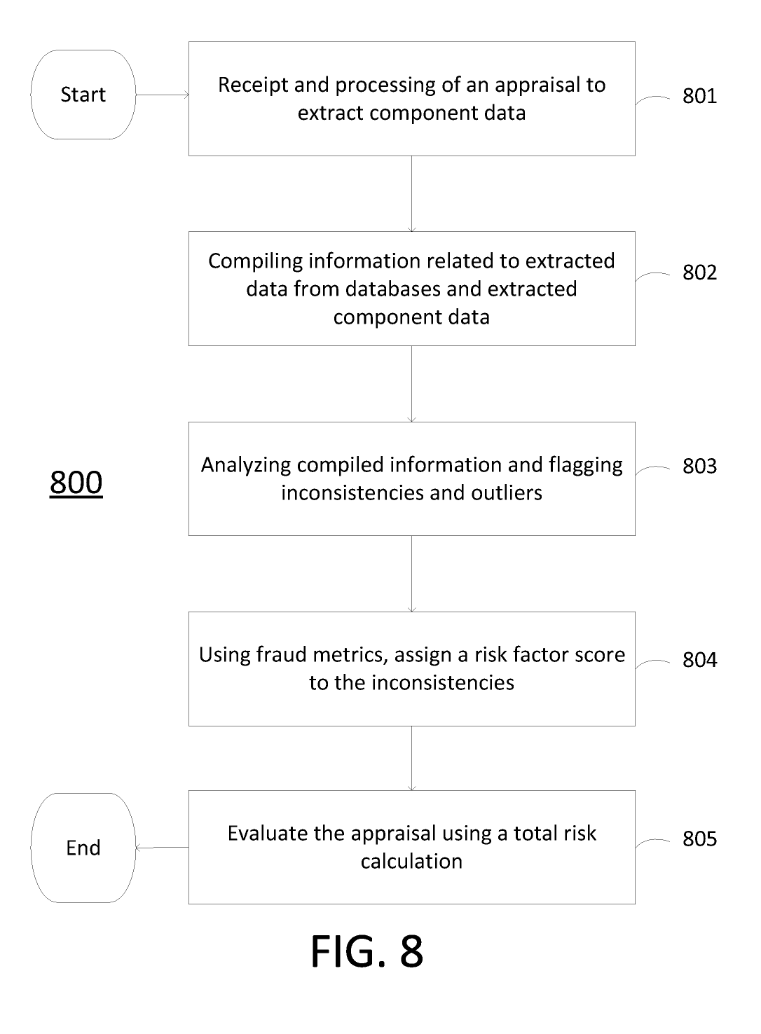

FIG. 8 is a flow diagram illustrating another example of an inconsistency evaluation process. Specifically, FIG. 8 is a flow diagram illustrating an example of the inconsistency evaluation process 800 that describes one possible operation sequence for the data discrepancy applications 100, 122, 123. The inconsistency evaluation process 800 begins by receiving and processing 801 an appraisal, such that the data listed within the appraisal is extracted and categorized. In processing the appraisal, the process 800 also determines a set of appraisal component categories. The set of appraisal component categories, in addition to the categories identified above, may also include data from public records, MLS listings, and GIS data. The process then compiles 802 comparison information related to the extracted component data from databases and from extracted component data. Compiling 802 may also be performed simultaneous with receipt and extraction 801 of component data. The process 800 next produces metrics based on analyzing 803 the determined set of appraisal component categories for contradictions and statistical variations. One example of a statistical variation includes the case where a process 800 compiles property repetition information, which is a number of times a comparable property has been listed on appraisals other than the received appraisal, and identifies changes in the descriptions of the “view” category. Statistical variations may also include appraiser history data that may show statistical tendencies of an individual appraiser. Next, metrics are scored 804 to create a set of scores representing risk factors for the determined set of appraisal component categories. The process then evaluates 805 the received appraisal for inconsistencies in a property value and a property characteristic based the set of scores. The inconsistencies and data discrepancies in property values and property characteristics may indicate the existence of user mistake, computer error, misrepresentation, potential fraud, altered property values, and altered property characteristics. Therefore, the process 800 provides a massive cross checking of digitally collected and generated information that may severely reduce the flexibility of appraisers to modify information about subjects and comparable properties in ways that support improper subject valuation.

Computing devices such as those disclosed herein may employ any of a number of computer operating systems, including, but by no means limited to, versions and/or varieties of the Microsoft Windows® operating system, the iOS by Apple Computer, Inc., Android by Google, Inc., the Unix operating system (e.g., the Solaris® operating system distributed by Sun Microsystems of Menlo Park, Calif.), the AIX UNIX operating system distributed by International Business Machines (IBM) of Armonk, N.Y., and the Linux operating system. Computing devices in general may include any one of a number of computing devices, including, without limitation, a computer workstation, a desktop, notebook, tablet, laptop, or handheld computer (such as a smartphone or personal digital assistant), or some other computing device.

Computing devices such as disclosed herein further generally each include instructions executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Further, the artisan will readily recognize the various alternative programming languages and execution platforms that are and will become available, and the described is not limited to any specific execution environment. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases or data stores described herein may include various kinds of mechanisms for storing, accessing, and retrieving various kinds of data, including a hierarchical database, a set of files in a file system, an application database in a proprietary format, a relational database management system (RDBMS), etc. Each such database or data store is generally included within a computing device employing a computer operating system such as one of those mentioned above, and are accessed via a network in any one or more of a variety of manners. A file system may be accessible from a computer operating system, and may include files stored in various formats. An RDBMS generally employs Structured Query Language (SQL) in addition to a language for creating, storing, editing, and executing stored procedures, such as the PL/SQL language mentioned above. Database may be any of a variety of known RDBMS packages, including IBMS DB2, or the RDBMS provided by Oracle Corporation of Redwood Shores, Calif.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

Thus, embodiments of the described produce and provide methods and apparatus for a model for providing real-time location-based promotions to a vehicle purchaser without the need for additional post-purchase decision conversations and signing ceremonies. Although the described is detailed considerably above with reference to certain embodiments thereof, the invention may be variously embodied without departing from the spirit or scope of the invention. Therefore, the following claims should not be limited to the description of the embodiments contained herein in any way.

1. A method for automatic detection of inconsistencies in an appraisal, comprising:
extracting, by a computer, data from the appraisal to create component data arranged into a predetermined set of categories;
selecting, by a computer, a control identifier to trigger a generation of comparison data; and
identifying, by a computer, inconsistencies based on a comparison between the comparison data and the component data.

2. The method of claim 1, wherein the control identifier is an appraiser identifier.

3. The method of claim 2, wherein the generation of comparison data comprises:
identifying an appraiser listed in the component data;
receiving historical appraiser data for the appraiser; and
generating the comparison data based on the historical appraiser data and at least one category from the predetermined set of categories.

4. The method of claim 1, wherein the control identifier is an appraisal identifier.

5. The method of claim 4, wherein the generation of comparison data comprises:
selecting at least two categories from the predetermined set of categories; and
generating component data based on the statistical relationship between the at least two categories.

6. The method of claim 1, wherein the control identifier is an external comparison.

7. The method of claim 6, wherein the generation of comparison data comprises:
selecting at least one category from the predetermined set of categories; and
generating component data based data external to the appraisal and relative to the at least one category.

8. The method of claim 1, further comprising:
providing, by a computer, a user interface that permits user review of the appraisal in a mapped format alongside additional information in which inconsistencies are identified.

9. A computer program product stored on a non-transitory computer readable medium that when executed by a computer performs operations for automatic detection of inconsistencies in an appraisal, comprising:
extracting, by a computer, data from the appraisal to create component data arranged into a predetermined set of categories;
selecting, by a computer, a control identifier to trigger a generation of comparison data; and
identifying, by a computer, inconsistencies based on a comparison between the comparison data and the component data.

10. The computer program product of claim 9, wherein the control identifier is an appraiser identifier.

11. The computer program product of claim 10, wherein the generation of comparison data comprises:
identifying an appraiser listed in the component data;
receiving historical appraiser data for the appraiser; and
generating the comparison data based on the historical appraiser data and at least one category from the predetermined set of categories.

12. The computer program product of claim 9, wherein the control identifier is an appraisal identifier.

13. The computer program product of claim 9, wherein the generation of comparison data comprises:
selecting at least two categories from the predetermined set of categories; and
generating component data based on the statistical relationship between the at least two categories.

14. The computer program product of claim 9, wherein the control identifier is an external comparison.

15. The computer program product of claim 14, wherein the generation of comparison data comprises:
selecting at least one category from the predetermined set of categories; and
generating component data based data external to the appraisal and relative to the at least one category.

16. The computer program product of claim 9, further comprising:
providing, by a computer, a user interface that permits user review of the appraisal in a mapped format alongside additional information in which inconsistencies are identified.
